(19) United States
(12) Patent Application Publication
(10) Pub. No.: US 2016/0008775 A1
(43) Pub. Date: Jan. 14, 2016

(54) A LIQUID PROCESSING MIXER

(71) Applicant: TETRA LAVAL HOLDINGS & FINANCE S.A., Pully (CH)

(72) Inventors: Hans Henrik MORTENSEN, Noerresundby (DK); Thomas PERMIN, Aalborg SO (DK); Frederik LARSEN, Dronninglund (DK)

(73) Assignee: TETRA LAVAL HOLDINGS & FINANCE S.A., Pully, OT (DK)

(21) Appl. No.: 14/770,730

(22) PCT Filed: Feb. 17, 2014
(86) PCT No.: PCT/EP2014/053026

§ 371 Date: Aug. 26, 2015

(30) Foreign Application Priority Data
Mar. 1, 2013 (SE) 1350248-9

(51) Int. Cl. B01F 5/06; B01F 15/02

(52) U.S. Cl. CPC B01F 5/0661; B01F 15/0243; B01F 15/026; B01F 2215/0014; B01F 2215/0031; B01F 2215/0032

(57) ABSTRACT

A liquid processing mixer is provided, comprising a mixing unit having a liquid inlet whereby a sub-pressure zone is provided upstream of the mixing unit, and wherein the liquid processing mixer further comprises at least one additive inlet connected to the sub-pressure zone for introducing the additive upstream of a high shear mixing device of the mixing unit.

### TECHNICAL FIELD

The present invention relates to a mixer for mixing liquid with liquid, gaseous, and/or solid additives. More particularly, the present invention relates to a mixer for processing hygienic substances, such as liquid food or cosmetics, as well as to a method for mixing such hygienic substances with various additives.

### BACKGROUND

In liquid processing industry, such as food processing, mixers are widely used for providing an efficient mix of liquids with solid and/or gaseous contents. Within this technical field it is common to divide the available mixers into i) batch mixers or ii) inline mixers. Typically, a batch mixer operates by circulating the media to be mixed within a tank and it is often a preferred choice for high viscous fluids. Inline mixers are typically operating in a different manner, in which the fluids are circulated outside the tank for continuously mixing liquid. As compared with batch mixers, inline mixers are often preferred for low viscous liquids and for large volume production.

The pumping ability of existing in-line mixers and especially existing in-line high-shear mixers is significantly reduced when the liquid viscosity is increased. At viscosities above 1000 cP their pumping ability is often completely lost, in particular if their pump performance is based on the centrifugal principle. Today this limits the use of inline mixers to mixing applications for relatively low viscous fluids.

An example of a food processing mixer is described in WO2009/089837. The mixer includes a tank with a plurality of filling openings and a discharge opening at the bottom of the tank. A high shear rotor mixer is arranged at the bottom of the tank, and is fluidly connected to a valve being capable of diverting mixed liquid either out from the tank or back into the tank. Solid particles to be mixed are introduced in the tank at a level below the current filling level.

Although such mixer is very well functioning and provides numerous advantages, it has been suggested to provide an improved mixer reducing the complexity as well as reducing the risk of having non-dissolved powder lumps present in the liquid.

### SUMMARY

It is, therefore, an object of the present invention to overcome or alleviate the above described problems.

The basic idea is to provide an in-line mixer having a two-stage mixing unit and a vacuum zone upstream of the mixing unit, whereby solid and/or liquid additives are introduced in the vacuum zone.

According to a first aspect a liquid processing mixer is provided. The mixer comprises a mixing unit having a liquid inlet whereby a sub-pressure zone is provided upstream said mixing unit, and wherein said liquid processing mixer further comprises at least one additive inlet connected to said sub-pressure zone for introducing said additive upstream a high shear mixing device of said mixing unit. Hence, bulk circulation is no longer required to draw down powders and liquid ingredients from the liquid surface since additives are not introduced in a de-aeration vessel. This means that the mixer speed (mixing intensity) may be adjusted arbitrary since too high speed will not result in inadequate mixing and ingredients lumping on the liquid surface due to a large vessel vortex, extensive in-mixing of air and thus foam generation.

Said mixing unit may comprise a pumping device and a mixing device arranged in series. Preferably, these two devices may be arranged in a single unit such that efficient pumping and corresponding mixing is achieved by the same unit.

Said pumping device may be a self-priming pump, such as a side channel pump, a liquid ring pump or a twin screw pump. Hence, very efficient pumping is provided, such that a sub-pressure may be provided upstream the mixing unit. Further, the use of these pumps also ensures efficient pumping during such sub-pressure conditions. If an existing inline mixer should be connected to an upstream de-aeration vessel in order to create a vacuum zone at the inlet their pumping performance is significantly reduced. The pumping performance of existing in-line mixers that operates according to the centrifugal principle is lost when the suction pressure is reduced below −0.6 bar due to cavitation inside the mixer. This phenomenon limits the efficiency and use of an upstream de-aeration vessel and/or limits the use of an upstream vacuum zone to draw-in ingredients. Hence, all these drawbacks are overcome when the pumping device is selected from a twin screw pump, a side-channel pump, or a liquid ring pump.

The mixing device may be a high shear mixer, such as a rotor-stator mixer.

The pumping device may be driven by a first motor, and the mixing device may be driven by a second motor. Alternatively, said pumping device and said mixing device may be driven by a common motor.

The liquid processing mixer may further comprise a throttle valve provided upstream of said mixing unit for creating said sub-pressure zone between said throttle valve and said mixing unit. This is advantageous in that the sub-pressure zone may be provided in a very simple and robust way requiring only minor additions to the mixer.

The liquid processing mixer may further comprise a pressure sensor for monitoring the pressure of said sub-pressure zone. Hence, process control is obtained in simple manner such that efficient mixing may be provided for a large number fo different applications.

The liquid processing mixer may comprise a de-aeration vessel provided upstream of said mixing unit for creating said sub-pressure zone between said de-aeration vessel and said mixing unit. Recirculation is thus possible for improving the mixing.

At least one of said additive inlets may be connected to a powder hopper, and each one of said additive inlets may be controlled by means of a corresponding valve. Hence, ingredient supply may be provided by opening of the valve, since the sub-pressure in the sub-pressure zone will draw the ingredients into the liquid flow.

According to a second aspect a liquid processing system is provided. The system includes processing equipment for processing liquid to be mixed and a mixer according to the first aspect in fluid connection with said processing equipment.

The liquid to be mixed is a hygienic liquid product, such as food, chemicals, pharmaceuticals, and/or cosmetics.

According to a third aspect, a method for providing a liquid processing mixer is provided. The method comprises the steps of providing a mixing unit downstream of a sub-pressure zone , and providing at least one additive inlet connected to said sub-pressure zone for introducing said additive upstream of a high shear mixer device of said mixing unit.

According to a fourth aspect, a method for mixing a liquid product by means of a mixer according to the first aspect is provided. The method comprises the steps of pumping liquid by means of said mixing unit; regulating a sub-pressure upstream of the mixing unit; and introducing an additive into said sub-pressure zone.

According to a fifth aspect, a liquid processing mixer is provided. The mixer comprises a mixing unit having a liquid inlet whereby a sub-pressure zone is provided upstream said mixing unit, and wherein said mixing unit comprises a pumping device arranged upstream of a high shear mixer device.

Preferably, the liquid processing mixer further comprises at least one additive inlet connected to said sub-pressure zone for introducing said additive upstream a high shear mixing device of said mixing unit.

Advantageous embodiments presented for the first aspect are also applicable for the fifth aspect.

### BRIEF DESCRIPTION OF DRAWINGS

The above, as well as additional objects, features, and advantages of the present invention, will be better understood through the following illustrative and non-limiting detailed description of preferred embodiments of the present invention, with reference to the appended drawings, wherein:

FIGS. 1a and 1b illustrate process schemes of parts of a liquid processing system including a mixer according to an embodiment;

FIG. 2 illustrates an embodiment of a mixer; and

FIG. 3 illustrates a further embodiment of a mixer.

### DETAILED DESCRIPTION

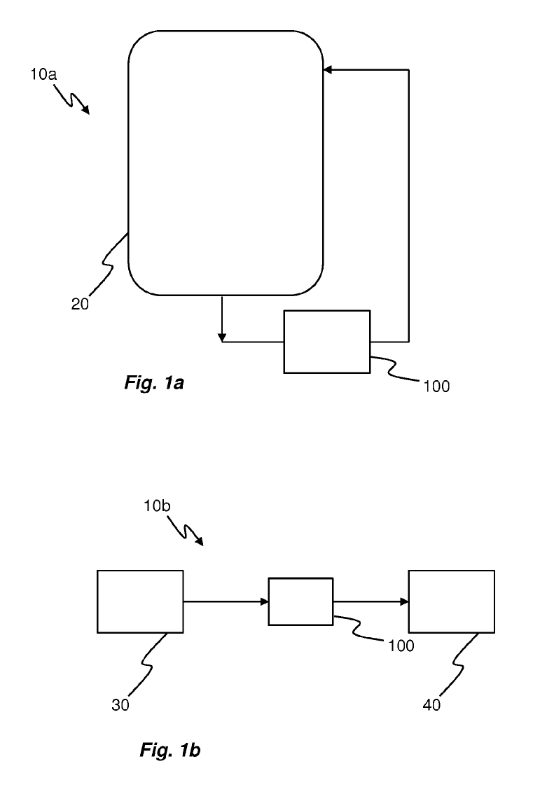

Starting with FIG. 1a, a part of a liquid processing 10a system is shown. The shown part may be included in a much larger processing system, including various liquid processing components such as heaters, homogenizers, separators, filters, etc in order to be able to completely, or partly, process a hygienic liquid product. An example of a liquid processing system 10a for use with the present invention is a liquid food processing system, capable of treating various liquid food products such as milk, juices, still drinks, ice creams, yoghurts, etc. However, a liquid processing system for use with the present invention may also include a system for treating and processing chemical, pharmaceutical, and/or cosmetic liquids.

The shown parts include a batch tank 20 and an in-line mixer 100 in fluid connection with the batch tank. Hence, liquid to be mixed is circulated through the mixer 100 being arranged outside the batch tank 20 for providing a large volume of mixed liquid.

In FIG. 1b, another example of a part of a liquid processing system 10b is shown. Here, a mixer 100 is arranged in series with an upstream processing part 30, and a downstream processing part 40. The upstream processing part 30 may be a batchtank, thus similar to what is shown in FIG. 1a, or another tank or processing equipment. Correspondingly, the downstream processing part 40 may be another batchtank, or other processing equipment. It should be readily understood that “other processing equipment” may include a single processing component, such as a heater, a homogenizer, a separator, a cooler, etc., or be a general description of a group of such processing components.

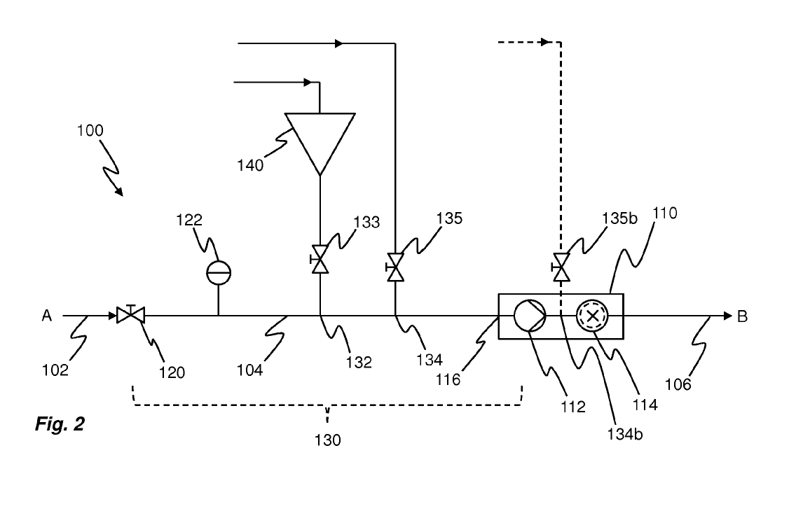

Now turning to FIG. 2, a mixer 100 according to an embodiment is shown schematically. The mixer 100 thus represents a mixer being suitable for inclusion in any of the processing systems described above with reference to FIGS. 1a or 1b. The mixer 100 has an inlet 102, receiving liquid to be mixed from the batch tank, or any upstream processing equipment, as indicated by the reference “A” in FIG. 2. From the inlet 102 the liquid to be mixed is transported through a suitable conduit, such as tubes or piping 104, into a mixing unit 110. Preferably, the mixing unit 110 is a two-stage mixing unit, including a pumping device 112 and a mixing device 114 arranged in series and downstream of the pumping device 112.

The pumping device 112 is preferably a self-priming pump stage, based on the side-channel principle in order to be able to pump and/or circulate both low and medium viscous products, e.g. in the range of 1-1000 cP even under poor suction conditions such as less than 0.3 Bar. In other embodiments, the pumping device 112 may include a twin screw pump, or a liquid ring pump providing substantially teh same pumping capacities as the side channel pump.

The mixer device 114 is preferably a high shear mixing stage, based on the rotor-stator principle. The high-shear mixing stage 114 is thus able to create high levels of shear and turbulence and is thereby able to disperse, emulsify and dissolve incorporated liquid and powder ingredients. The rotor-stator system creates none or very limited pumping effect and for some viscosities it might even cause a pressure drop.

The pumping device and the mixing device 112, 114 may be driven by one common motor or alternatively by two separate motors. The total motor size will be chosen to somewhere around 15 kW, such as between 12 and 15 kW. For a total power of 15 kW, i.e. approximately 7.5 kW for each stage, proof-of-concept tests have verified that more than 35 m³/h may be circulated at 2.5 bar for low viscous products in the range of approximately 1 cP. The same power also provides circulation of more than 25 m³/h of medium viscous products, in the range of approximately 1000 cP, at 2.5 Bar. These particular capacities allow powder introduction at required rate, as will be further discussed in the following.

As previously described, the mixing unit 110 may be configured to circulate liquid over a batch tank 20. In such embodiment, preferably the mixing unit 110 is located close to the batch tank for eliminating the need for an inlet pump or outlet booster pump. Further, the mixer 100 includes an outlet 106 for connecting the mixer 100 with an inlet of the batch tank, as indicated by “B” in FIG. 2.

A throttle valve 120 is preferably used to create a sub-pressure zone, or vacuum zone 130 upstream of the mixing unit 110, i.e. between said throttle valve and the mixing unit. The actual vacuum level may be indicated by means of a pressure sensor 122, such as a manometer in fluid connection with the vacuum zone 130. Preferably, the throttle valve 120 is a seat or membrane valve being electronically controlled.

The vacuum zone 130 includes at least one additive inlet 132, 134, for allowing the insertion of additional compounds in the liquid to be mixed. Additional compounds may for example involve solid powder representing particular flavours or other ingredients, as well as further liquids such as oils etc.

The ingredient inlets 132, 134 are preferably arranged in the vacuum zone 130, i.e. between the throttle valve 120 and the mixer unit 110.

Powder ingredients are preferably introduced a bit longer upstream than liquid ingredients since some spreading and pre-wetting of powders are beneficial for dispersing and dissolving while liquid ingredients are best introduced immediately before the mixing stage 110, especially in hot-cold emulsification processes. In specific embodiments the powder inlet 132 may be connected to a powder hopper 140, a big-bag station etc. or mounted with a hopper for manual de-bagging.

Each additive inlet 132, 134 is preferably arranged in fluid connection with a respective inlet valve 133, 135. The opening of the additive inlet valves 133, 135 may be set arbitrary to control dosing rate and can be closed rapidly by the operator, e.g. in case a powder rat-hole is emerging.

In a yet further embodiment, an additive inlet 134b is provided within the mixing unit 110 just upstream of the high-shear mixer device 114. This is indicated in FIG. 2, where a corresponding control valve 135b is provided to allow further ingredient addition via the inlet 134b. The additive inlet 134b may replace the previously described inlet 134, or it may be provided as an additional inlet. Preferably, the optional inlet 134b is used for including further liquids, such as oil, into the main liquid to be processed.

The location of the powder additive inlet valve(s) 133 in-line with the liquid product stream makes back-flush, i.e. when liquid enters the dry phase, almost impossible and significantly reduce the risk of powder valve related production stops.

In fact, proof-of-concept tests have verified that that powder interface remain dry even if the powder introduction valves are defect and left partly opened.

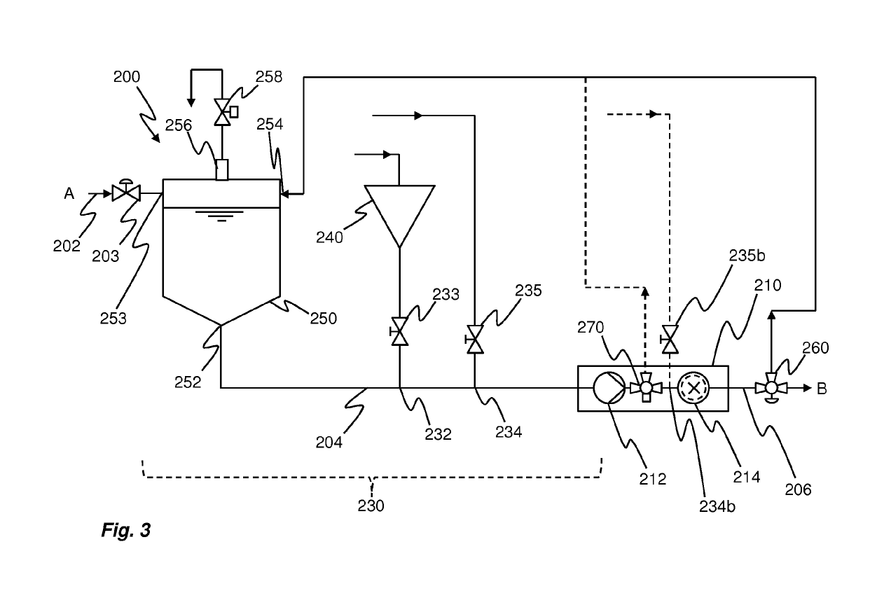

Now turning to FIG. 3, another embodiment of a mixer 200 is shown. The mixer is similar to the mixer 100 of FIG. 1, i.e. it includes an inlet 202, a mixing unit 210, and a sub-pressure zone 230 provided upstream of the mixing unit 210. The mixing unit 210 is a two-stage mixing unit, including a pumping device 212 and a mixing device 214 similarly to what has been described previously. Further, additive inlets 232, 234, 234b are provided for adding solid, liquid, or gaseous content to the liquid flowing through the mixer 200. Additional valves 233, 235, 235b are provided for each inlet 232, 234, 234b in order to control the amount of ingredient to be added.

However, the sub-pressure zone 230 is for this embodiment provided by means of a de-aeration vessel 250 in fluid connection with the mixing unit 210, and hence the pumping device 212.

The liquid is guided into the de-aeration vessel 250, having a liquid outlet 252 arranged at the bottom end. Liquid exits the de-aeration vessel 250 through the outlet 252 and is further guided by means of a pipe or other suitable conduit 204 into the mixing unit 210. Between the outlet 252 and the mixing unit 210 the additive inlets 232, 234 are provided for allowing additives, such as powder or further liquids, to be introduced into the liquid flowing from the de-aeration vessel 250.

The mixing unit 210 provides a mechanical treatment of the liquid for further improving the mixing. An outlet end of the mixing unit 210 is connected to a further pipe 206 which is connected to a three-way valve 260 at its opposite end. The three-way valve 260 is thus capable to direct the liquid flow through a first port connected to an inlet 254 of the de-aeration vessel 250, a second port connected to the batch tank (not shown) or any other downstream processing equipment, or both. The three-way valve 260 is thus capable of providing a varying ratio for de-aeration vessel recirculation vs. output to e.g. batchtank. In fact, the three-way valve 260 may be controlled continuously for any given ration.

The upper part of the de-aeration vessel 250 has an air outlet 256 for allowing air to escape from the vessel 250, which outlet 256 is controlled by means of a de-aeration valve 258.

Before turning into specific details of the different components shown in FIG. 3, a general explanation of the working principle of the mixer 200 will be given.

When a liquid is to be mixed, e.g. in a situation where solid additives are to be finely dispersed or dissolved with a liquid product, the initial liquid is stored in the batch tank or flowing in an upstream processing equipment. The liquid is then fed into the de-aeration vessel 250, which is filled up to a predetermined maximum level. At this point, the vessel 250 is sealed off from the atmosphere and the mixing unit 210 is controlled to draw liquid out from the de-aeration vessel 250. Upon drawing liquid from the vessel 250, the liquid level within the vessel 250 will drop whereby the pressure inside the vessel 250 will drop correspondingly. When the desired vacuum level is reached the circulation flow over the batch tank, or output to downstream processing equipment, is established by means of the three-way valve 260, being configured to re-circulate a part of the outlet stream from the mixing unit 210 back into the vessel 250, and the remaining part to the batch tank or further downstream processing equipment.

During mixing, the liquid level may be reduced in order to maintain the vacuum in the vessel 250 by continuously controlling the position of the three-way valve 260. When the liquid level reaches a predefined low level limit, the position of the three-way valve 260 will change for providing 100% recirculation of the liquid into the vessel 250. Correspondingly, the vacuum is released by opening the ventilation valve 258. Further liquid is then introduced into the vessel 250 from the inlet 202 thus pushing out the air in the vessel 250 headspace. It should be noted that generated foam, e.g. larger bubbles will collapse when the vacuum is released. This “foam-kill” system ensures that no or very little product/foam is pushed out in this re-filling step.

Now returning to FIG. 3, the liquid supply is controlled by an inlet valve 203 arranged at the inlet 202 upstream the de-aeration vessel 250. The inlet valve 203 is preferably controlled such that the liquid level within the de-aeration vessel 250 is within predefined intervals.

As already described, the mixer unit 210 contains two stages, which in one embodiment may be a self-priming pumping device 212 based on the twin-screw principle, and a high-shear mixing device 214 based on the rotor-stator principle. Typically, a twin screw pump has a cylindrical body in which two parallel and eccentric screws are meshing with each other. When rotating the screws, liquid will be drawn thus providing a pumping action.

In other embodiments, the pumping device 212 may be a liquid ring pump or a side-channel pump. In general, the pumping device 212 should be a self priming pump.

The pumping device 212 is preferably able to pump/circulate both low and high-viscous products, e.g. in the range of 1-100000 cP even under very poor suction conditions such as below 0.15 Bar. The proposed twin-screw device is advantageous in that it will only impart a very limited shear on the circulated fluid while at the same time also allowing non-disruptive passing of large particles. As an example, particles having a diameter of 20 mm may be flown through the pumping device 212; however the exact size depends on selected screw pitch of the twin screws.

The pumping device 212 is thus capable of providing a sub-pressure within the de-aeration vessel 250, as well as being capable of pumping liquid out from said de-aeration vessel also in the presence of such sub-pressure.

The mixing device 214, i.e. the device used to provide high-shear mixing, is able to create high levels of shear and turbulence and thus to disperse, emulsify and/or dissolve incorporated liquid and powder ingredients. The proposed rotor-stator system is thus capable of creating none or very limited pumping effect and for some viscosities it might even cause a pressure drop.

Between said pumping device 212 and said mixing device 214, a three-way valve 270 may be provided for enabling by-passing of the high-shear mixing device 214 thereby allowing incorporation of shear sensitive ingredients and/or large particles. Preferably, the bypass valve 270 may be controlled continuously for any given ratio of mixed/unmixed liquid. The provision of a bypass valve provides an additional advantage over prior art mixers, since existing inline mixers cannot vary the shear imparted on the fluid for a constant rotational speed, and are not able to allow non-disruptive passing of large and/or shear sensitive particles.

By using a high performance twin screw pump 212, vacuum inside the vessel 250 may be generated by using the superior suction performance of the pumping device 212 to pump out product from the initially filled-up and then sealed-off vessel 250.

The pumping device 212 and the mixing device 214 may in this embodiment be driven by one common motor or alternatively by two separate motors, as already described with reference to FIG. 2.

In a yet further embodiment, the additive inlet 234b is provided within the mixing unit 210 just upstream of the high-shear mixer device 214.

When exiting the mixing unit 210, the liquid is directed by the three-way valve 260 for either returning to the batch tank (or flowing to downstream processing equipment) or for returning to the de-aeration vessel 250. As previously been described, the three-way valve 260 may be controlled continuously to provide any given ratio between de-aeration vessel recirculation and output to batchtank or further processing equipment. The position of the three-way valve 260 may thus be controlled in order to obtain constant vacuum inside the de-aeration vessel 250.

The de-aeration vessel 250 may for this purpose be equipped with nozzles 253, 254 distributing the two inlet streams, i.e. the main inlet 253 coming from the batch tank and the re-circulation inlet 254 coming from the mixing unit 210 smoothly over the tank wall. This is primarily for generating a large product surface area that enhances de-aeration and secondly to avoid splashing and thus foam generation. Both inlets 253, 254 are located above liquid surface resulting in a first-in-first-out vessel 250. In some embodiment, the de-aeration vessel 250 may also be provided with an internal stirrer for improving the turbulence within the vessel 250.

Hence, the present mixer does not require bulk circulation since ingredients are introduced between the de-aeration vessel 250 and the mixer unit 210. Therefore all ingredients in the de-aeration vessel 250 have been through the mixer unit 210 at least once reducing the need for extensive bulk circulation for reducing the risk of powder lumps , oils etc floating on the liquid surface in the de-aeration vessel 250. Bulk circulation may e.g. be created only by the two tangential inlet streams coming from the main inlet and 253 and the recirculation inlet 254.

The present embodiment reduces the need for a separate vacuum pump. This fully removes the risk of foam overrun through the vacuum system caused by bubble and foam growth. Naturally such product loss is un-desirable and leads to hygienic and cleaning problems. In addition to this, a de-aeration vessel connected to a vacuum pump cannot be used if the product is toxic or for other reasons cannot escape the vessel/system.

In view of above, the speed of the pumping device 212 can thus be adjusted arbitrary and is not limited by vortex and foam constraints. The only air introduced in the present mixer 200 is the air embedded in the ingredients. The part of the embedded air that is evacuated by the vacuum will correspondingly be accumulated in the de-aeration vessel.

In a yet further embodiment, the mixer 200 is provided with a vacuum pump (not shown) connected to the de-aeration vessel 250 for pumping excessive air out from the de-aeration vessel 250. The size of the vacuum pump may be relatively small, e.g. in the range of 2 kW for a liquid ring pump since the amount of air to be evacuated is limited to the amount of air embedded in the product ingredients. This is due to the fact that no air is incorporated due to vortex entrainment and surface whipping as described above. The vacuum level is preferably controlled by speed/frequency regulation of the vacuum pump combined with a bleed valve (not shown) based on input from a pressure transmitter (not shown).

The present embodiments reduces known problems of prior art systems such as product-atmosphere exposure, air-incorporation via vessel vortex, powder over-dosing via manual de-bagging, troublesome manual level control, manual CIP-pipe mounting etc.

The disclosed embodiments of a liquid processing mixer 100 may preferably also be equipped with a cleaning-in-place (CIP) system, capable of cleaning the components without dismounting the mixer 100, 200.

Although the above description has been made mostly with reference to a liquid food processing system, it should be readily understood that the general principle of the mixer is applicable for various different liquid processing systems.

Further, the invention has mainly been described with reference to a few embodiments. However, as is readily understood by a person skilled in the art, other embodiments than the ones disclosed above are equally possible within the scope of the invention, as defined by the appended claims.

1. A liquid processing mixer, comprising a mixing unit having a liquid inlet whereby a sub-pressure zone is provided upstream said mixing unit, and wherein said liquid processing mixer further comprises at least one additive inlet connected to said sub-pressure zone for introducing said additive upstream a high shear mixing device of said mixing unit.

2. The liquid processing mixer according to claim 1, wherein said mixing unit comprises a pumping device and a mixing device arranged in series.

3. The liquid processing mixer according to claim 2, wherein said pumping device is a self-priming pump.

4. The liquid processing mixer according to claim 4, wherein said pumping device is a side channel pump, a liquid ring pump or a twin screw pump.

5. The liquid processing mixer according to claim 2, wherein said mixing device is a high shear mixer.

6. The liquid processing mixer according to claim 5, wherein said mixing device is a rotor stator mixer.

7. The liquid processing mixer according to claim 2, wherein said pumping device is driven by a first motor, and said mixing device is driven by a second motor.

8. The liquid processing mixer according to claim 2, wherein said pumping device and said mixing device are driven by a common motor.

9. The liquid processing mixer according to claim 1, further comprising a throttle valve provided upstream of said mixing unit for creating said sub-pressure zone between said throttle valve and said mixing unit.

10. The liquid processing mixer according to any one of the preceding claims claim 1, further comprising a pressure sensor for monitoring the pressure of said sub-pressure zone.

11. The liquid processing mixer according to claim 1, further comprising a de-aeration vessel provided upstream of said mixing unit for creating said sub-pressure zone between said de-aeration vessel and said mixing unit.

12. The liquid processing mixer according to claim 1, wherein at least one of said additive inlets is connected to a powder hopper.

13. The liquid processing mixer according to claim 1, wherein each one of said additive inlets are controlled by means of a corresponding valve.

14. A liquid processing system, including processing equipment for processing liquid to be mixed and a mixer according to claim 1 in fluid connection with said processing equipment.

15. The liquid processing system according to claim 14, wherein said liquid to be mixed is a hygienic liquid product, such as food, chemicals, pharmaceuticals, and/or cosmetics.

16. A method for providing a liquid processing mixer, comprising:
providing a mixing unit downstream of a sub-pressure zone, and
providing at least one additive inlet connected to said sub-pressure zone for introducing said additive upstream of a high shear mixer device of said mixing unit.

17. A method for mixing a liquid product by a mixer according to claim 1, comprising:
pumping liquid by way of said mixing unit;
regulating a sub-pressure upstream of the mixing unit; and
introducing an additive into said sub-pressure zone.
